(19) United States
(12) Patent Application Publication
(10) Pub. No.: US 2017/0203300 A1
(43) Pub. Date: Jul. 20, 2017

(54) CHOPPING BLADE OF HARDENED STEEL, CHOPPING DRUM AND CHOPPING DRUM ASSEMBLY

(71) Applicant: GEBRUEDER BUSATIS GMBH, PURGSTALL AN DER ERLAUF (AT)

(72) Inventors: ALOIS KROELL, PURGSTALL AN DER ERLAUF (AT); WOLFGANG LUTZ, WIESELBURG (AT)

(21) Appl. No.: 15/475,452

(22) Filed: Mar. 31, 2017

Related U.S. Application Data
(63) Continuation-in-part of application No. 14/244,917, filed on Apr. 4, 2014.

(30) Foreign Application Priority Data
Apr. 4, 2013 (AT) GM111/2013

(51) Int. Cl. B02C 18/18

(52) U.S. Cl. CPC B02C 18/18; B02C 2210/02

(57) ABSTRACT

A chopping blade for cutting against a shear bar has a main body made of hardened steel. The blade body is formed with at least one cutting-edge region, a fastening region for fastening the blade to a carrier and in each case a transition region between the cutting-edge region and the fastening region. The main body bears a hard material coating in the cutting-edge region. The hardness of the main body is uniform throughout over all regions. A chopping drum carries a multiplicity of these chopping blades on its periphery and, upon rotation of the chopping drum, the chopping blades cut material upon running up against a stationary shear bar.

### CROSS-REFERENCE TO RELATED APPLICATION

This application is a continuation-in-part of application Ser. No. 14/244,917, filed Apr. 4, 2014; the application also claims the priority, under 35 U.S.C. §119, of Austrian utility model application GM 111/2013, filed Apr. 4, 2013; the prior applications are herewith incorporated by reference in their entirety.

### BACKGROUND OF THE INVENTION

### Field of the Invention

The invention relates to a chopping blade having a main body which is made of hardened steel. The blade has at least one cutting-edge region, a fastening region and in each case a transition region lying between the cutting-edge region and the fastening region.

Chopping blades are produced in different forms. Irrespective of their form, however, they have at least one cutting-edge region and a fastening region.

In order to keep the cutting edge of a chopping blade sharp for as long as possible, and to thereby ensure a good cutting quality over a long period of time, so that long service lives arise, it is known to provide the chopping blades with a hard material layer in the cutting-edge region on the side lying opposite the oblique side, this hard material layer extending up to the cutting edge of the main body. Owing to the high hardness of the hard material particles (see, e.g., U.S. Pat. No. 6,067,784 and its counterpart European patent EP 0 875 323 B1), the hard material layer withstands the wear caused by the cut material very effectively, whereas the underlying material of the main body is removed by wear. This combination of materials of differing hardness which therefore undergo differing rates of wear gives rise to a self-sharpening effect for the cutting edge of the blade, which is thereby kept sharp. If the main body consists of unhardened steel, the wear to the main body proceeds very quickly, and the relatively brittle hard material coating bursts after a certain period of time, such that the blades have to be replaced. Ideally, the main body is therefore also hardened, in which case a hardness of approximately 55 HRC has proved suitable in practice; given this hardness, the difference in hardness relative to the hard material layer gives rise to the desired self-sharpening effect as a result of a differing degree of wear, and nevertheless the wear to the main body takes place slowly and therefore the bursting of the hard material layer is delayed in such a way that long service lives arise.

In the fastening region, the chopping blade is provided with openings for the passage of fastening screws, with which the blade is fastened to the chopping drum via a blade carrier, preferably with the interposition of a clamping strip or of shaped pieces for pressure distribution. In this region, the blade is subjected to clamping forces and impact loads upon contact between the blade and foreign bodies, such as stones. The transition region lying between the cutting-edge region and the fastening region lies in the blade projection and is subjected to considerable bending forces and also impact loads, in particular also upon contact with foreign bodies. In order that no cracks are formed and the blade does not fracture on account of the clamping, bending and impact forces, the blade has to be sufficiently tough and elastic in the transition region and in the fastening region so as not to suffer any damage. In practice, a hardness of the blade in these regions of approximately 40 HRC has been found to be suitable here.

Prior art chopping blades presently on the market therefore have a main body which is hardened to approximately 40 HRC in the fastening region and in the transition region, is hardened to approximately 55 HRC in the cutting-edge region and bears a hard material coating. For this purpose, by way of example, the main body provided with the hard material layer can be hardened overall to 40 HRC, and then the cutting-edge region can be hardened to 55 HRC by, for example, inductive selective hardening.

Although each region is therefore set to an ideal hardness for the loading which arises there, instances of premature cracking and fracturing can occur in the case of such prior art blades. The reason for this lies in the different heat treatment microstructure of the regions of differing hardness, with a drop in hardness also being formed at the boundary between the regions of varying hardness, since, in the selective hardening, the heat treatment microstructure formed beforehand is annealed again in the boundary region.

The different heat treatment microstructure in the regions of differing hardness leads to different coefficients of volume expansion of the regions, as a result of which residual stresses, which are the cause of the cracks and fractures observed, form in the transition region.

### SUMMARY OF THE INVENTION

It is accordingly an object of the invention to provide a chopping blade and a chopping drum which overcome a variety of disadvantages of the heretofore-known devices and methods of this general type.

With the foregoing and other objects in view there is provided, in accordance with the invention, a chopping blade for cutting against a shear bar, the chopping blade comprising:
a main body of hardened steel having at least one cutting edge bounding a cutting edge region, a fastening region, and a transition region between said cutting-edge region and said fastening region;
a hard material coating in said cutting-edge region of said main body; and
said main body having a uniform hardness of between 44 and 52 HRC throughout the entire said main body with said cutting edge region, said transition region, and said fastening region, and said main body having the characteristics of having been heat treated for a time period of less than 5 minutes, preferably less than 2 minutes, or even less than 1 minute, and at a temperature of above 900° C.

In other words, the object is achieved by a chopping blade having a main body which is made of hardened steel. The body has at least one cutting-edge region, a fastening region and in each case a transition region lying between the cutting-edge region and the fastening region. The main chopping blade body bears a hard material coating in the cutting-edge region, and the hardness of the main body is uniform over all regions.

It is preferable here, too, that the heat treatment microstructure is uniform over all regions. In particular, the microstructure may be a martensitic or a bainitic heat treatment microstructure. The uniform hardening of the base body is achieved, in accordance with the invention, by subjecting the device to fast heat treatment. The heat treatment is preferably by way of induction hardening with a heating phase of less than 5 minutes. In a preferred embodiment, the heating phase lasts even less than 2 minutes. The process temperature thereby lies above 900° C.

Advantageously, the hardness of the main body lies uniformly between 44 and 52 HRC, in particular between 46 and 50 HRC, and is preferably 48 HRC. The term HRC is dimensionless and refers to the Rockwell scale C used in the hardness tester of the Rockwell type.

By virtue of the uniform hardness and the possibly uniform heat treatment microstructure of the main body, the residual stresses no longer occur between the cutting-edge region and the transition region and the fastening region, and therefore also no cracking and no instances of fracture arise. At the same time, the chopping blade is less expensive to produce, since only one hardening operation has to be performed.

By choosing the uniform hardness from the aforementioned value ranges, there is still sufficient wear resistance in the cutting-edge region and at the same time sufficient toughness and elasticity in the fastening region and in the transition region in order to make it possible to withstand bending, clamping and impact forces which arise.

Here, the thickness of the hard material layer can vary over the length of the main body. Depending on the geometry of the chopping apparatus bearing the chopping blade, loading of differing levels and wear of differing extents can occur over the length of the main body of the chopping blade. The different thickness of the hard material layer takes this into account. Here, the thickness can vary between 0.1 and 1 mm, in particular between 0.2 and 0.4 mm.

With the above and other objects in view there is also provided, in accordance with the invention, a chopping drum, comprising:
a rotationally symmetrical carrier body mounted to a rotary shaft and having a periphery; and
a plurality of chopping blades, each as summarized above, mounted on the periphery of said carrier body and each being disposed to have a respective said cutting edge pointed in a common tangential direction.

Finally, with the above and other objects in view there is also provided, in accordance with the invention, a chopping drum assembly, comprising:
a stationary shear bar;
a rotationally symmetrical carrier body mounted to a rotary shaft and having a periphery; and
a plurality of chopping blades, each formed as summarized above, mounted on said periphery of said carrier body and each being disposed to have a respective said cutting edge pointed in a common tangential direction and aligned so that, upon rotation of the chopping drum about said rotary shaft, said chopping blades run past said shear bar at a cutting gap and, in cooperation with said shear bar, cut material moving into said cutting gap.

Other features which are considered as characteristic for the invention are set forth in the appended claims.

Although the invention is illustrated and described herein as embodied in a chopping blade and a chopping drum with a plurality of such blades, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE SEVERAL VIEWS OF THE DRAWING

FIG. 1 is an elevation view of an exemplary chopping drum with several chopping blades fastened thereto;

FIG. 2 is a sectional and schematic view illustrating a blade and its corresponding hardness profile along its width, including that of a prior art blade and or a blade according to the invention; and

FIG. 3 is a partial diagrammatic view showing a chopping blade as it passes by a stationary shear bar in a chopping drum assembly.

### DETAILED DESCRIPTION OF THE INVENTION

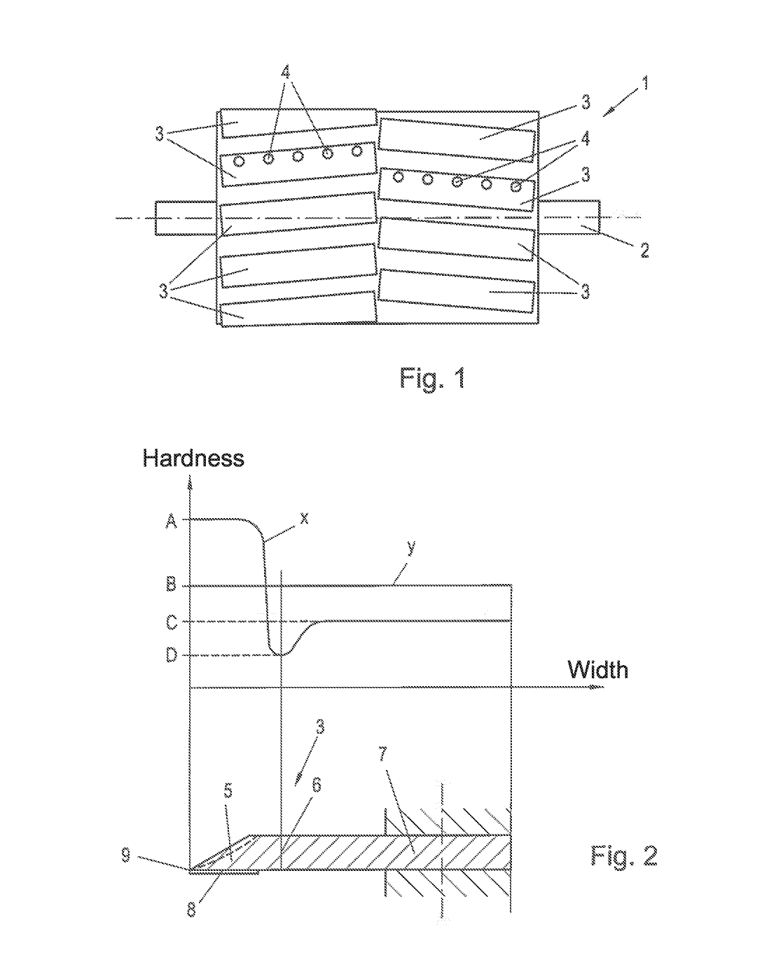

Referring now to the figures of the drawing in detail and first, particularly, to FIG. 1 thereof, there is shown a chopping drum 1 with a rotary shaft 2. A plurality of chopping blades 3 are attached to the peripheral wall about the circumference of the drum 1. The blades have cutting edges that are all pointing in the same forward direction, here referred to as a common tangential direction. A variety of different blade forms are possible, such as flat blades, blades bent about their longitudinal axis or coiled blades. Also, they may be provided in an extremely wide variety of lengths and they may be arranged parallel or inclined with respect to the axis of rotation of the drum in an extremely wide variety of patterns, such as oriented or offset in relation to one another. In the exemplary drum, provision is made of two rows of blades alongside one another, the blades 3 each being inclined with respect to the axis of rotation and each row of blades being inclined in a different direction with respect to the axis of rotation. The blades 3 are fastened to the drum by way of screws 4, as is indicated on a respective blade 3 of each row of blades.

FIG. 2 is a sectional view of a flat chopping blade 3. The chopping blade has a main body with three regions along its width, namely, a cutting-edge region 5, a transition region 6 and a fastening region 7. In the cutting-edge region 5, that side of the main body of the blade 3 which lies opposite the oblique side bears a hard material layer 8 extending along the cutting edge 9. In use, the main body becomes worn more quickly by the cut material in the cutting-edge region 5 than the hard material layer 8, giving rise to a self-sharpening effect, as indicated by a dashed line. In the fastening region 7, the main body of the blade 3 has an opening serving for the passage of one of the fastening screws (shown in FIG. 1). The latter may screwed, for example, directly into a thread in a blade carrier of the chopping drum. On the side of the screw head, provision can be made of a pressure plate for distributing the clamping forces which act here, in addition to impact loads, on the main body. The transition region 6 lies between the cutting-edge region 5 and the fastening region 7 of the main body, belongs to the blade projection and can be exposed to high bending and impact loads.

The graph shows the hardness profile over the width of a chopping blade of the prior art (curve X=prior art) and over the width of a chopping blade according to the invention (curve Y). In the cutting-edge region, the main body of the blade of the prior art (curve X) has a hardness A, for example, 55 HRC, which drops in the transition region and, after a drop in hardness to approximately a natural hardness D of the main body, such as, for example 30 HRC, changes into a hardness C, for example 40 HRC, in the fastening region.

The different hardnesses are achieved by conventional heat treatment processes and are reflected in different heat treatment microstructures, as a result of which different coefficients of volume expansion also arise in the various regions, leading to residual stresses.

In the case of the main body of the blade of the present invention, by contrast, the hardness and preferably also the heat treatment microstructure is uniformly at value B, such as, for example, 48 HRC, over the entire width. That is, the hardness is constant from the cutting edge 9 as far as the end of the fastening region 7 remote from the cutting edge 9, and therefore no residual stresses can arise and also the production is facilitated. Given a suitable choice of the uniform hardness B, excessive wear cannot be observed in the cutting-edge region and also damage caused by bending, impact or clamping forces does not occur in the transition region and in the fastening region.

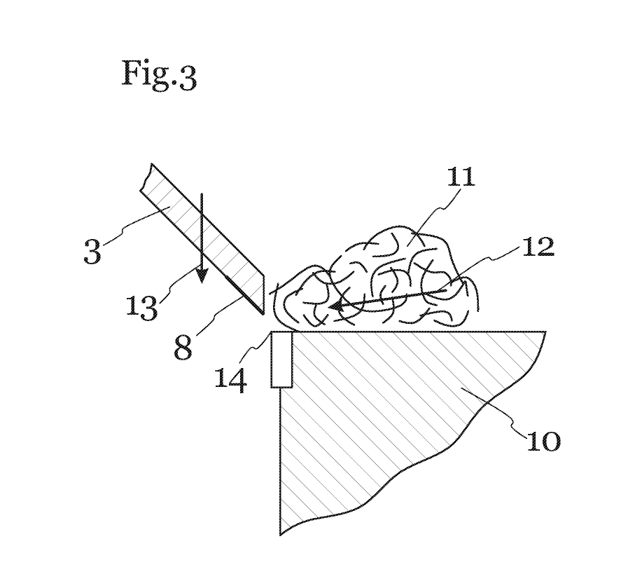

FIG. 3 is a schematic showing the interaction between a chopping blade 3, which is mounted on a chopping drum 1, and a stationary shear bar 10 during a cutting process. The material 11 to be cut, for example harvest material such a straw, corn stalk, maize, sugar cane, and the like, is pushed in the direction of the arrow 12 towards a cutting edge 14 of the shear bar 10. As the cutting edge of the blade 3 moves in the direction of the arrow 13 past the cutting edge 14, the material 11 is cut by the interaction between the blade 3 and the shear bar 10. This process results in very high forces that act on the chopping blade 3 (and also the shear bar or counter-blade 10), requiring the blade 3 to have superior hardness.

1. A chopping blade for cutting against a shear bar, the chopping blade comprising:
a main body of hardened steel having at least one cutting edge bounding a cutting edge region, a fastening region, and a transition region between said cutting-edge region and said fastening region;
a hard material coating in said cutting-edge region of said main body; and
said main body having a uniform hardness of between 44 and 52 HRC throughout the entire said main body with said cutting edge region, said transition region, and said fastening region, and said main body having the characteristics of having been heat treated for a time period of less than 5 minutes and at a temperature of above 900° C.

2. The chopping blade according to claim 1, wherein said main body has been heat treated for less than 2 minutes.

3. The chopping blade according to claim 1, wherein said main body has a microstructure formed by heat treatment and said microstructure of said main body is uniform over all said regions.

4. The chopping blade according to claim 4, wherein said microstructure of said main body is a martensitic or a bainitic heat treatment microstructure.

5. The chopping blade according to claim 1, wherein the hardness of said main body is uniform and has a uniform value between 46 and 50 HRC.

6. The chopping blade according to claim 5, wherein the hardness of said main body has a uniform value of substantially 48 HRC.

7. The chopping blade according to claim 1, wherein a thickness of said hard material layer varies over a length of said main body.

8. The chopping blade according to claim 7, wherein the thickness of said hard material layer varies within a range between a minimum thickness of 0.1 mm and a maximum thickness of 1 mm.

9. The chopping blade according to claim 8, wherein the thickness of said hard material layer varies within a range between a minimum thickness of 0.2 mm and a maximum thickness of 0.4 mm.

10. A chopping drum, comprising:
a rotationally symmetrical carrier body mounted to a rotary shaft and having a periphery; and
a plurality of chopping blades, each according to claim 1, mounted on said periphery of said carrier body and each being disposed to have a respective said cutting edge pointed in a common tangential direction.

11. A chopping drum assembly, comprising:
a stationary shear bar;
a rotationally symmetrical carrier body mounted to a rotary shaft and having a periphery; and
a plurality of chopping blades, each according to claim 1, mounted on said periphery of said carrier body and each being disposed to have a respective said cutting edge pointed in a common tangential direction and aligned so that, upon rotation of the chopping drum about said rotary shaft, said chopping blades run past said shear bar at a cutting gap and, in cooperation with said shear bar, cut material moving into said cutting gap.
